(19) United States
(12) Patent Application Publication
(10) Pub. No.: US 2007/0029442 A1
(43) Pub. Date: Feb. 8, 2007

(54) Method for supporting a propelled flying object during take-off and/or landing

(76) Inventor: Klaus Wolter, Duesseldorf (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/559,655

(22) PCT Filed: May 26, 2004
(86) PCT No.: PCT/EP04/05642

§ 371 Date: May 12, 2006

(30) Foreign Application Priority Data
Jun. 6, 2003 (DE) 103261443
Jun. 18, 2003 (DE) 103277439
Jun. 23, 2003 (DE) 103282920

(51) Int. Cl. B64F 1/00

(52) U.S. Cl. 244/114 R

(57) ABSTRACT

The invention relates to a method for assisting a propelled flying object during landing and/or takeoff of. For assistance a, related to a landing and/or a takeoff area 10, stationary-generated fluid current is provided in order to introduce energy into the flying object. The invention likewise relates to an apparatus, which has a fluid current generator 11 for generating the fluid current.

### CROSS-REFERENCE TO RELATED APPLICATIONS

This application is a National Phase of PCT/EP2004/005642, filed May 26, 2004, which is based on German Application No. 103 26 144.3, filed Jun. 6, 2003; German Application No. 103 27 743.9, filed on Jun. 18, 2003; and German Application No. 103 28 292.0, filed on Jun. 23, 2003, and are hereby incorporated by reference.

### BACKGROUND OF THE INVENTION

The invention relates to a method and an apparatus for assisting the landing and/or takeoff of a propelled flying object.

A flying object here designates any object that is capable of moving by means of its own propulsion in the atmosphere of a planet having no contact with the ground, for example, an aircraft.

The takeoff and landing process represents a special challenge both in the construction and in the use of such flying objects.

For the takeoff and landing of a flying object, long takeoff and landing runways are normally necessary. Providing long takeoff and landing runways, however, is time and cost-intensive. Added to this is the fact that not every place has sufficient space available for regular takeoff and landing runways. This is particularly the case on sea-based landing units but can also be a problem elsewhere, for instance in mountainous areas. Here it may be necessary to assist a landing operation on a short runway by involves of arrestor cables, for which a particularly exact controlled approach is essential. Such a method means a high cost in the training of the crew.

### SUMMARY OF THE INVENTION

The object of the invention is to provide a method and an apparatus that assist the takeoff and/or landing operation of a propelled flying object in a particularly simple way.

On the one hand, the object is achieved by a method wherein, relative to a landing and/or takeoff area, a stationary-generated fluid current is provided in order to introduce energy into the flying object.

On the other hand, the object is achieved by an apparatus, which has at least one stationary fluid current generator, relative to a landing and/or a takeoff area, which is designed to provide a fluid current in order to introduce energy into a flying object.

The invention is based on the consideration that, even without employing mechanical aids, the energy for positive or negative acceleration of a flying object for takeoff or landing does not have to be supplied by the flying object alone. On the contrary, a fluid current directed towards the flying object can assist the deceleration or acceleration of the flying object.

It is an advantage of the invention that it can be applied universally and flexibly. It permits the takeoff and landing of a flying object to be assisted in an easy-to-handle way without the need for a long runway. Furthermore, it is an advantage of the invention that it is independent of the kind of landing place, weather and type of flying object. The system according to the invention can therefore be implemented economically in a simple manner and within a short time.

Also the flying objects, whose takeoff and/or landing are assisted according to the invention, can be configured more simply than up to now, since they no longer need to be able to take off or land entirely on their own. Should certain components used for landing, as, for example, wheels, be no longer necessary, this also increases safety since any susceptibility to failure of these components is no longer relevant.

Advantageous embodiments of the invention are described herein. In an advantageous embodiment of the invention, the direction of the fluid current can be adjusted depending on the situation. In this case the direction also comprises the angle relative to the takeoff and/or landing area. The situation can be determined, for example, by the approach direction, height and/or distance of the flying object. If several separate fluid currents are used, advantageously their direction can be adjusted individually.

In a further advantageous embodiment of the invention, at least one physical parameter of the fluid current can be adjusted depending on the situation. Such a physical parameter can be, for example, temperature of the fluid current, density of the fluid current, velocity of the fluid current, homogeneity of the fluid current or laminarity ratio of the fluid current. In this case, the situation can be determined, for example, by ambient temperature, speed of the flying object, type of the flying object, distance of the flying object, etc.

The temperature can be varied by heating elements and/or cooling elements. By increasing the temperature of the fluid current, for example, formation of fog can be avoided or also icing over of the flying object may be avoided or curbed. If the temperature of the fluid current is reduced, for example, overheating of the flying object can be prevented.

If the fluid current provided has a certain specific density, the effectiveness of the fluid current, that is to say its deceleration effect and/or its acceleration effect, can be increased as a result of it being enriched with at least one substance of higher specific density.

Likewise, if necessary, a fire-extinguishing agent can be introduced into the fluid current provided, for instance, in order to fight a fire in a flying object already on its approach. The fluid current provided, for example, can be wind generated artificially from the existing atmosphere, a matter stream or a mass flow. The fluid current generator used to produce the fluid current can be a fluid current generator known from practice, for example, a blower such as a turbofan conventionally used for aircraft. If presently available fluid current generators are used, the system according to the invention can be implemented particularly quickly.

To assist the landing of a flying object in one embodiment of the invention, a fluid current is first generated, which is capable of decelerating the flying object. Subsequently, the fluid current is controlled in such a way that the flying object is lowered from a hovering position onto a landing area.

To assist the takeoff of a flying object in one embodiment of the invention, a fluid current is first provided, which is capable of lifting the flying object from a takeoff area to a hovering position. Subsequently, a fluid current is provided, which is capable of accelerating the flying object in a desired direction.

In a further embodiment of the invention for assisting the takeoff of a flying object, the latter first accelerates in a conventional way. The actual takeoff, that is to say taking off from the ground, however, is then assisted and thus accelerated by the method according to the invention and the apparatus according to the invention, respectively. Correspondingly, a flying object landing in a conventional way can be assisted in deceleration shortly after hitting the runway by the method according to the invention and the apparatus according to the invention, respectively. Thus, long takeoff or landing runways are no longer needed, but only a short distance necessary for acceleration. Depending on the type of aircraft, this distance can be 50 to 100 metres. This concept is advantageous in that it allows existing takeoff and landing runways to be upgraded.

Advantageously, all adjustments of the fluid current can be determined and carried out automatically by means of a control device.

A method and/or an apparatus for assisting the takeoff and/or landing operation of objects, which are capable of moving in the atmosphere of a planet having no contact with the ground (that is to say no part of the object has any contact with the ground). At least one layer of molecular thickness of the atmosphere lies between the object (i.e., flying objects, such as an aircraft) and ground, is characterized in that such an object during takeoff and/or landing is accelerated (positive as well as negative acceleration is meant here in the sense of the physical definition) and is thus launched and/or landed in an atmospheric current (i.e., wind, matter stream, or mass flow) controlled with respect to all parameters (temperature, density, homogeneity, laminarity) generated, for example, by strong fans, possibly also mounted rotatably and adjustably in the spatial directions. In order to increase the efficiency of acceleration, the atmospheric current can be intensified by enrichment with substances of higher specific density (for example, water droplets can be injected, other enrichment materials are also conceivable, as long as these suit the purpose).

In one embodiment of this method and/or apparatus in the case of the landing operation for example, the idea is to let the flying object fly into a not necessarily controlled matter stream, which through its kinetic energy combined with the propulsive power of the flying object reduces the speed of the flying object relative to the ground to zero and due to its intrinsic velocity gives the flying object the necessary lift for hovering as the result of the matter stream flowing against the aerodynamic surfaces of the flying object (further details on this subject can be read up in any physics text book). By reversing or reducing or generally controlling (possible change of all geometric parameters (x, y, z, angles) as well as change of the physical parameters is meant here) the matter stream as well as the propulsion of the object, the latter can now be lowered onto the ground.

The same method and/or apparatus can now also be used in a reverse way for takeoff. For example, takeoff operations can be visualized similarly as in the case of tow launching a glider, whereby in the analogy the functions, represented by a combination of winding the cable, acceleration of the flying object and generation of the head wind, here are taken over by a stationary rotatable blower and the engine of the flying object. Also here limitation to this single example, as also in the case of the landing operation, does not go far enough by a long way, since a method of takeoff is to be seen in particular as a function of the aircraft type.

A further preferred embodiment is, however, illustrated, since it represents one from the plurality, which will most likely result in quick implementation as well as acceptance. In this embodiment, the method/apparatus described above is partially used: the flying object initially accelerates as normal and is then finally launched before the end of the classic process by the new method and/or apparatus presented here. This variation is interesting in a transitional phase for upgrading existing airports, where the extension of an existing runway is out of the question and the operators do not want a complete conversion (at present interesting for the Hamburg AIRBUS-Airport extension!).

In a further preferred embodiment of the method and/or apparatus, by controlling the temperature of the matter stream the formation of fog or also icing over of the object in the vicinity of the working space is avoided and/or removed or overheating is reduced, for example.

Also, for example, in a further embodiment, a fire-extinguishing agent, as for example fire extinguishing foam can be introduced in a controlled way, especially also selectively, into the matter stream.

In a further preferred embodiment, all control processes are automated and implemented by normal control units, for example, on a computer basis.

In order to give a further visual example, the ball dancing on a water fountain or in an air current is cited here. A preferred embodiment is designed similarly and this with all conceivable case differentiations and possible solutions, for example, concerning the laminarity or homogeneity of the matter stream. In a further preferred embodiment, large turbofans, as they are found in commercial aviation, are used as blowers.

All this leads to the fact that this method and/or apparatus can be implemented within a very short time (only months (!) of development time!).

The method and/or apparatus for assisting the takeoff and/or landing operation of flying objects, presented here, can be used in land as well as sea-based applications and at the same time completely independent of the weather. Likewise, it is independent of the development of the flying object(s).

Amongst the wide range of advantages, others apart from those mentioned above ought to be highlighted:

Low costs for training the flying personnel: the indescribable procedure by means of arrestor cables for landing, for which an exact controlled approach is necessary, comes to mind. Likewise the takeoff operation is substantially simpler==>cost and time saving!

Modular construction: sea as well as land-based units can be constructed identically.

Maximum flexibility and mobility: no takeoff or landing runway necessary; only the necessary space required for acceleration (depending on the aircraft, less than 50-100 m), that is to say this part of the required logistics is no longer necessary. The building, for example, of military airports is almost totally redundant==>cost and time saving!

Lower structural complexity in the construction of aircraft, i.e., more pay load. Thus, no longer any need to build VTOL aircraft for supersonic flight. Fewer moving parts=higher (technical) safety. Consequently: less highly specialized personnel and reduced technical expertise.

### BRIEF DESCRIPTION OF THE DRAWINGS

A version of the invention is described in detail below on the basis of an exemplary embodiment with reference to drawings, wherein:

FIG. 1 shows a schematic illustration of a takeoff and landing unit as exemplary embodiment of the apparatus according to the invention, and

FIG. 2 is a flow chart, which illustrates the operation of the takeoff and landing unit in FIG. 1.

### DETAILED DESCRIPTION OF THE DRAWINGS

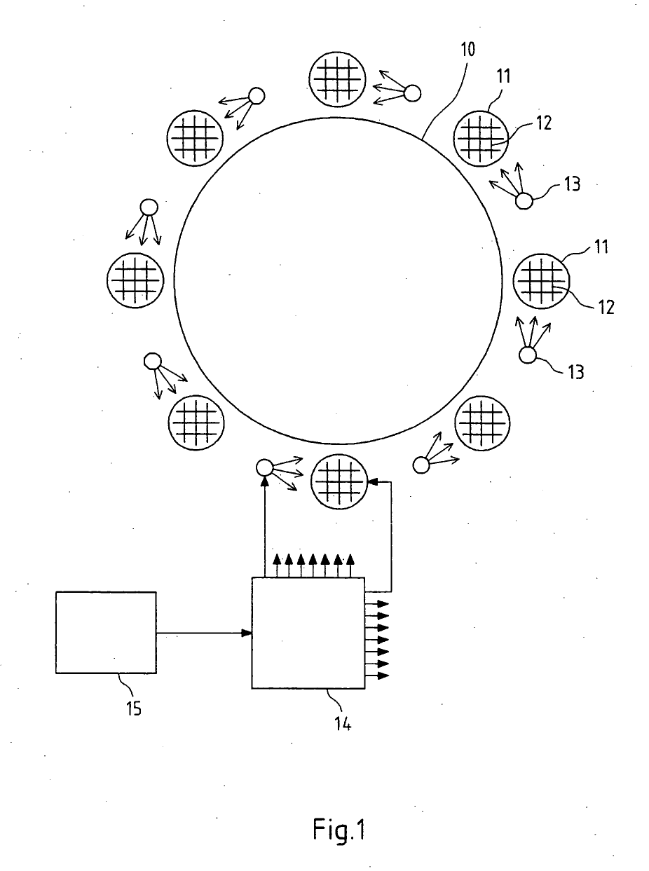

FIG. 1 is a schematic illustration of a takeoff and landing unit, which assists the takeoff and landing of an aircraft according to the invention. The aircraft in this case can be a conventional type.

The takeoff and landing unit has a circular takeoff and landing area 10. Eight large turbofans 11 are installed at equal distance around the takeoff and landing area 10. Each of the turbofans 11 is rotatably mounted and has a temperature control element. The temperature control element comprises a grill-type insert 12 within the air outlet vicinity of the respective turbofan 11, wherein the temperature of the grill-type insert 12 is variable.

Additionally, a spraying device 13, which can inject water droplets into the air outlet vicinity of the turbofans 11, is assigned to each of the turbofans 11

Furthermore, the takeoff and landing unit has a computerized control device 14. The control device 14 is connected to a data-acquisition and receiving apparatus 15. This includes temperature sensors as well as receiving means for incoming signals sent by approaching aircraft. The control device 14 also has a controlling access to each of the turbofans 11 as well as to each of the spraying devices 13. For reasons of clarity, this access is only illustrated by way of example for one of the turbofans 11 and one of the spraying devices 13.

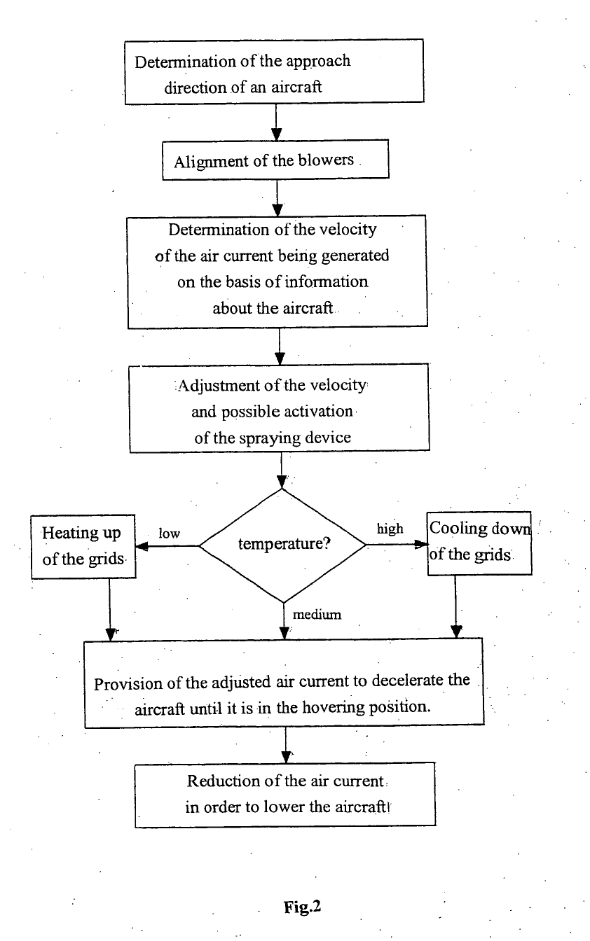

The flow chart in FIG. 2 illustrates the functional mode of the takeoff and landing unit in FIG. 1.

If an aircraft is on its approach for landing, the control device 14 first determines the approach direction of the aircraft. This can be done, for example, on the basis of coordinates, which are transmitted by the aircraft to the receiving means of the data acquisition and receiver unit 15. Alternatively or additionally, the approach direction can also be determined on the basis of ground-based measurements of flight parameters. The control device 14 then aligns the rotatable turbofans 11 via control signals so that an air current to be generated is directed towards the aircraft.

In addition, the aircraft transmits information about the aircraft itself, for example, its speed, height, weight and shape, which is received by the receiving means of the data-acquisition and receiver unit 15. Based on this information, the control device 14 determines the velocity of the air current to be generated needed for decelerating the aircraft. More exactly, the velocity is adjusted via control signals to the turbofans 11 so that by combining the propulsive power of the aircraft and this counteracting kinetic energy of the air current, the speed of the aircraft is reduced to zero. If necessary, the efficiency of the air current in this case can be increased further, by commanding the spraying devices via control signals of the control device 14 to inject water droplets into the air current to be generated, which increases the density of the current. If necessary, the spraying devices 13 can also be commanded via control signals of the control device 14 to inject a fire-extinguishing agent into the air current to be generated.

It goes without saying that the necessary velocity of the air current to be generated can also be determined, alternatively or additionally, on the basis of ground-based measurements of flight parameters.

Moreover, the temperature sensor of the data-acquisition and receiving unit 15 determines the ambient temperature. With a particularly low ambient temperature, the control device 14 via control signals to the turbofans 11 causes the grills 12 of the temperature control elements to be heated up, in order to prevent icing over due to water droplets injected into the air current or to remove existing icing over of the aircraft. With a particularly high ambient temperature, the control device 14 via control signals to the turbofans 11 causes the grills 12 of the temperature control elements to be cooled down in order to prevent overheating of the aircraft.

The turbofans 11, possibly assisted by the spraying devices 13, now provide an air current with the adjusted parameters and the aircraft flies into this air current. Thereby the aircraft is decelerated and brought to a hovering position over the takeoff and landing area 10. For this purpose, the direction and other parameters of the air current of the turbofans 11 can be carried along with the aircraft by corresponding activation by the control device 14.

If the aircraft is in this position, the control device 14 via corresponding control signals to the turbofans 11 commands the speed of the air current generated to be reduced, so that the aircraft is lowered onto the ground. Alternatively or additionally for lowering the aircraft various parameters of the air current generated, for example the quantity of water injected by the spraying devices 13 into the air current can also be changed via control signals of the control device 14.

Takeoff of an aircraft is assisted in the reverse order to that described for landing an aircraft.

For takeoff, the aircraft is first brought into a start position between the turbofans 11. The control device 14 now runs through a pre-set start-off program, according to which the turbofans 11 first generate and provide an air current, which brings the aircraft into a hovering position over the take off and landing runway. From this position, the aircraft is accelerated by means of its own engines and additionally by corresponding adjustment and intensification of the air current supplied by the turbofans 11. The adjustment of the air current in this case depends on the planned flight direction of the aircraft.

Alternatively, some of the turbofans 11 can also be used to generate an air current increasing in intensity and directed against the aircraft. At the same time, the aircraft's own power is then used to accelerate the aircraft relative to the air current flowing against it.

The intensity of the air current and the aircraft's own power are coordinated so that the aircraft moves as little as possible away from its start position. If sufficient relative acceleration is achieved, the aircraft can take off as with the conventional takeoff process from the start area 10. This concept enables the runway, which is necessary for acceleration of an aircraft taking off under its own power to be substantially shortened.

The air current is varied to a desired temperature by the control device 14 via control signals to the turbofans 11, as in the landing operation, by means of the temperature control elements. Moreover, the control device 14 in order to increase the efficiency of the air current can again command the spraying devices 13 to inject water droplets into the air current generated.

The embodiment described only represents one, which is selected from a plurality of possible embodiments of the method according to the invention and of the apparatus according to the invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### Method for Assisting a Propelled Flying Object During Landing and Takeoff

The invention relates to a method and an apparatus for assisting the landing and/or takeoff of a propelled flying object.

Flying object here designates any object, which is capable of moving by means of its own propulsion in the atmosphere of a planet having no contact with the ground as for example an aircraft.

The takeoff and landing process represents a special challenge both in the construction and in the use of such flying objects.

For the takeoff and landing of a flying object long takeoff and landing runways are normally necessary. The provision of long takeoff and landing runways however is time and cost-intensive. Added to this is the fact that not every place has sufficient space available for regular takeoff and landing runways. This is particularly the case on sea-based landing units but can also represent a problem elsewhere, for instance in mountainous areas. Here it may be necessary to assist a landing operation on a short runway by means of arrestor cables, for which a particularly exact controlled approach is essential. Such a method means a high cost in the training of the crew.

The object of the invention is to provide a method and an apparatus, which assist the takeoff and/or landing operation of a propelled flying object in a particularly simple way.

On the one hand the object is achieved by a method wherein a, relative to a landing and/or takeoff area, stationary-generated fluid current is provided in order to introduce energy into the flying object.

On the other hand the object is achieved by an apparatus, which has at least one, relative to a landing and/or a takeoff area, stationary fluid current generator, which is designed to provide a fluid current in order to introduce energy into a flying object.

The invention is based on the consideration that even without employing mechanical aids the energy for positive or negative acceleration of a flying object for takeoff or landing does not have to be supplied by the flying object alone. On the contrary a fluid current directed towards the flying object can assist the deceleration or acceleration of the flying object.

It is an advantage of the invention that it can be applied universally and flexibly. It permits the takeoff and landing of a flying object to be assisted in an easy to handle way without the need for a long runway. Furthermore it is an advantage of the invention that it is independent of the kind of landing place, weather and type of flying object. The system according to the invention can therefore be implemented economically in a simple manner and within a short time.

Also the flying objects, whose takeoff and/or landing are assisted according to the invention, can be configured more simply than up to now, since they no longer need to be able to take off or land entirely on their own. Should certain components used for landing, as for example wheels, be no longer necessary, this also increases safety since any susceptibility to failure of these components is no longer relevant.

Advantageous embodiments of the invention ensue from the dependent claims.

In an advantageous embodiment of the invention the direction of the fluid current can be adjusted depending on the situation. In this case the direction also comprises the angle relative to the takeoff and/or landing area. The situation can be determined for example by the approach direction, height and/or distance of the flying object. If several separate fluid currents are used, advantageously their direction can be adjusted individually.

In a further advantageous embodiment of the invention at least one physical parameter of the fluid current can be adjusted depending on the situation. Such a physical parameter can be for example temperature of the fluid current, density of the fluid current, velocity of the fluid current, homogeneity of the fluid current or laminarity ratio of the fluid current. In this case the situation can be determined for example by ambient temperature, speed of the flying object, type of the flying object, distance of the flying object etc.

The temperature can be varied by heating elements and/or cooling elements. By increasing the temperature of the fluid current for example formation of fog can be avoided or also icing over of the flying object may be avoided or curbed. If the temperature of the fluid current is reduced for example, overheating of the flying object can be prevented.

If the fluid current provided has a certain specific density, the effectiveness of the fluid current, that is to say its deceleration effect and/or its acceleration effect can be increased, as a result of it being enriched with at least one substance of higher specific density.

Likewise if necessary a fire-extinguishing agent can be introduced into the fluid current provided, for instance in order to fight a fire in a flying object already on its approach.

The fluid current provided for example can be wind generated artificially from the existing atmosphere, a matter stream or a mass flow. The fluid current generator used to produce the fluid current can be a fluid current generator known from practice, for example a blower such as a turbofan conventionally used for aircraft. If presently available fluid current generators are used, the system according to the invention can be implemented particularly quickly.

To assist the landing of a flying object in one embodiment of the invention firstly a fluid current is generated, which is capable of decelerating the flying object. Subsequently, the fluid current is controlled in such a way that the flying object is lowered from a hovering position onto a landing area.

To assist the takeoff of a flying object in one embodiment of the invention firstly a fluid current is provided, which is capable of lifting the flying object from a takeoff area to a hovering position. Subsequently, a fluid current is provided, which is capable of accelerating the flying object in a desired direction.

In a further embodiment of the invention for assisting the takeoff of a flying object the latter first accelerates in a conventional way. The actual takeoff, that is to say taking off from the ground, however is then assisted and thus accelerated by the method according to the invention and the apparatus according to the invention, respectively. Correspondingly a flying object landing in a conventional way can be assisted in deceleration shortly after hitting the runway by the method according to the invention and the apparatus according to the invention, respectively. Thus long takeoff or landing runways are no longer needed, but only a short distance necessary for acceleration. Depending on the type of aircraft this distance can be 50 to 100 meters. This concept is advantageous in that it allows existing takeoff and landing runways to be upgraded.

Advantageously all adjustments of the fluid current can be determined and carried out automatically by means of a control device.

A method and/or an apparatus for assisting the takeoff and/or landing operation of objects, which are capable of moving in the atmosphere of a planet having no contact with the ground (that is to say no part of the object has any contact with the ground. At least one layer of molecular thickness of the atmosphere lies between object (=flying objects, aircraft) and ground), is characterized in that such an object during takeoff and/or landing is accelerated (positive as well as negative acceleration is meant here in the sense of the physical definition) and is thus launched and/or landed in an atmospheric current (=wind, matter stream, mass flow) controlled with respect to all parameters (temperature, density, homogeneity, laminarity) generated for example by strong fans, possibly also mounted rotatably and adjustably in the spatial directions. In order to increase the efficiency of acceleration, the atmospheric current can be intensified by enrichment with substances of higher specific density (for example water droplets can be injected, other enrichment materials are also conceivable, as long as these suit the purpose).

In one embodiment of this method and/or apparatus in the case of the landing operation for example, the idea is to let the flying object fly into a not necessarily controlled matter stream, which through its kinetic energy combined with the propulsive power of the flying object reduces the speed of the flying object relative to the ground to zero and due to its intrinsic velocity gives the flying object the necessary lift for hovering as the result of the matter stream flowing against the aerodynamic surfaces of the flying object (further details on this subject can be read up in any physics text book). By reversing or reducing or generally controlling (possible change of all geometric parameters (x, y, z, angles) as well as change of the physical parameters is meant here) the matter stream as well as the propulsion of the object, the latter can now be lowered onto the ground.

The same method and/or apparatus can now also be used in a reverse way for takeoff. For example takeoff operations can be visualized similarly as in the case of tow launching a glider, whereby in the analogy the functions, represented by a combination of winding the cable, acceleration of the flying object and generation of the head wind, here are taken over by a stationary rotatable blower and the engine of the flying object. Also here limitation to this single example, as also in the case of the landing operation, does not go far enough by a long way, since a method of takeoff is to be seen in particular as a function of the aircraft type.

A further preferred embodiment is however illustrated, since it represents one from the plurality, which will most likely result in quick implementation as well as acceptance. In this embodiment the method/apparatus described above is partially used: the flying object initially accelerates as normal and is then finally launched before the end of the classic process by the new method and/or apparatus presented here. This variation is interesting in a transitional phase for upgrading existing airports, where the extension of an existing runway is out of the question and the operators do not want a complete conversion (at present interesting for the Hamburg AIRBUS-Airport extension!).

In a further preferred embodiment of the method and/or apparatus by controlling the temperature of the matter stream the formation of fog or also icing over of the object in the vicinity of the working space is avoided and/or removed or overheating is reduced for example.

Also for example in a further embodiment a fire-extinguishing agent, as for example fire-extinguishing foam can be introduced in a controlled way, especially also selectively, into the matter stream.

In a further preferred embodiment all control processes are automated and implemented by normal control units for example on a computer basis.

In order to give a further visual example, the ball dancing on a water fountain or in an air current is cited here. A preferred embodiment is designed similarly and this with all conceivable case differentiations and possible solutions for example concerning the laminarity or homogeneity of the matter stream. In a further preferred embodiment large turbofans, as they are found in commercial aviation, are used as blowers.

All this leads to the fact that this method and/or apparatus can be implemented within a very short time (only months (!) of development time!).

The method and/or apparatus for assisting the takeoff and/or landing operation of flying objects, presented here, can be used in land as well as sea-based applications and at the same time completely independent of the weather. Likewise it is independent of the development of the flying object(s).

Amongst the wide range of advantages, others apart from those mentioned above ought to be highlighted:
Low costs for training the flying personnel: the indescribable procedure by means of arrestor cables for landing, for which an exact controlled approach is necessary, comes to mind. Likewise the takeoff operation is substantially simpler==>cost and time saving!
Modular construction: sea as well as land-based units can be constructed identically.
Maximum flexibility and mobility: no takeoff or landing runway necessary; only the necessary space required for acceleration (depending on the aircraft less than 50-100 m), that is to say this part of the required logistics is no longer necessary. The building for example of military airports is almost totally redundant==>cost and time saving!
Lower structural complexity in the construction of aircraft, i.e. more pay load. Thus no longer any need to build VTOL aircraft for supersonic flight. Fewer moving parts=higher (technical) safety. Consequently: less highly specialized personnel and reduced technical expertise.

A version of the invention is described in detail below on the basis of an exemplary embodiment with reference to drawings, wherein:

FIG. 1 shows a schematic illustration of a takeoff and landing unit as exemplary embodiment of the apparatus according to the invention, and

FIG. 2 is a flow chart, which illustrates the operation of the takeoff and landing unit in FIG. 1.

FIG. 1 is a schematic illustration of a takeoff and landing unit, which assists the takeoff and landing of an aircraft according to the invention. The aircraft in this case can be a conventional type.

The takeoff and landing unit has a circular takeoff and landing area 10. Eight large turbofans 11 are installed at equal distance around the takeoff and landing area 10. Each of the turbofans 11 is rotatably mounted and has a temperature control element. The temperature control element comprises a grill-type insert 12 within the air outlet vicinity of the respective turbofan 11, wherein the temperature of the grill-type insert 12 is variable. Additionally a spraying device 13, which can inject water droplets into the air outlet vicinity of the turbofans 11, is assigned to each of the turbofans 11.

Furthermore the takeoff and landing unit has a computerized control device 14. The control device 14 is connected to a data-acquisition and receiving apparatus 15. This comprises temperature sensors as well as receiving means for incoming signals sent by approaching aircraft. The control device 14 also has a controlling access to each of the turbofans 11 as well as to each of the spraying devices 13. For reasons of clarity this access is only illustrated by way of example for one of the turbofans 11 and one of the spraying devices 13.

The flow chart in FIG. 2 illustrates the functional mode of the takeoff and landing unit in FIG. 1.

If an aircraft is on its approach for landing, the control device 14 first determines the approach direction of the aircraft. This can be done for example on the basis of coordinates, which are transmitted by the aircraft to the receiving means of the data-acquisition and receiver unit 15. Alternatively or additionally the approach direction can also be determined on the basis of ground-based measurements of flight parameters. The control device 14 aligns then the rotatable turbofans 11 via control signals so that an air current to be generated is directed towards the aircraft.

In addition the aircraft transmits information about the aircraft itself, for example its speed, height, weight and shape, which is received by the receiving means of the data-acquisition and receiver unit 15. Based on this information the control device 14 determines the velocity of the air current to be generated needed for decelerating the aircraft. More exactly the velocity is adjusted via control signals to the turbofans 11 so that by combining the propulsive power of the aircraft and this counteracting kinetic energy of the air current the speed of the aircraft is reduced to zero. If necessary, the efficiency of the air current in this case can be increased further, by commanding the spraying devices via control signals of the control device 14 to inject water droplets into the air current to be generated, which increases the density of the current. If necessary the spraying devices 13 can also be commanded via control signals of the control device 14 to inject a fire-extinguishing agent into the air current to be generated.

It goes without saying that the necessary velocity of the air current to be generated can also be determined alternatively or additionally on the basis of ground-based measurements of flight parameters.

Moreover the temperature sensor of the data-acquisition and receiving unit 15 determines the ambient temperature. With a particularly low ambient temperature the control device 14 via control signals to the turbofans 11 causes the grills 12 of the temperature control elements to be heated up, in order to prevent icing over due to water droplets injected into the air current or to remove existing icing over of the aircraft. With a particularly high ambient temperature the control device 14 via control signals to the turbofans 11 causes the grills 12 of the temperature control elements to be cooled down in order to prevent overheating of the aircraft.

The turbofans 11, possibly assisted by the spraying devices 13, now provide an air current with the adjusted parameters and the aircraft flies into this air current. Thereby the aircraft is decelerated and brought to a hovering position over the takeoff and landing area 10. For this purpose the direction and other parameters of the air current of the turbofans 11 can be carried along with the aircraft by corresponding activation by the control device 14.

If the aircraft is in this position, the control device 14 via corresponding control signals to the turbofans 11 commands the speed of the air current generated to be reduced, so that the aircraft is lowered onto the ground. Alternatively or additionally for lowering the aircraft various parameters of the air current generated, for example the quantity of water injected by the spraying devices 13 into the air current can also be changed via control signals of the control device 14.

Takeoff of an aircraft is assisted in the reverse order to that described for landing an aircraft.

For takeoff the aircraft is first brought into a start position between the turbofans 11. The control device 14 now runs through a pre-set start-off program, according to which the turbofans 11 first generate and provide an air current, which brings the aircraft into a hovering position over the take off and landing runway. From this position the aircraft is accelerated by means of its own engines and additionally by corresponding adjustment and intensification of the air current supplied by the turbofans 11. The adjustment of the air current in this case depends on the planned flight direction of the aircraft.

Alternatively some of the turbofans 11 can also be used to generate an air current increasing in intensity and directed against the aircraft. At the same time the aircraft's own power is then used to accelerate the aircraft relative to the air current flowing against it. The intensity of the air current and the aircraft's own power are coordinated so that the aircraft moves as little as possible away from its start position. If sufficient relative acceleration is achieved, the aircraft can take off as with the conventional takeoff process from the start area 10. This concept enables the runway, which is necessary for acceleration of an aircraft taking off under its own power to be substantially shortened.

The air current is varied to a desired temperature by the control device 14 via control signals to the turbofans 11, as in the landing operation, by means of the temperature control elements. Moreover the control device 14 in order to increase the efficiency of the air current can again command the spraying devices 13 to inject water droplets into the air current generated.

The embodiment described only represents one, which is selected from a plurality of possible embodiments of the method according to the invention and of the apparatus according to the invention.

1.-21. (canceled)

22. A method for assisting the landing and/or takeoff of a powered flying object, comprising:
providing a stationary-generated fluid current relative to a landing and/or takeoff area in order to introduce energy into said flying object.

23. The method of claim 22, wherein a direction of said fluid current is adjusted depending on a situation.

24. The method of claim 22, wherein a value of at least one physical parameter of said fluid current is adjusted depending on a situation.

25. The method of claim 24, wherein said at least one physical parameter comprises at least one of the following: a temperature of said fluid current, a density of said fluid current, a velocity of said fluid current, a homogeneity of said fluid current, and a laminarity rate of said fluid current.

26. The method of claim 22, wherein said fluid current has a certain specific density and, if necessary, is enriched by at least one substance of higher specific density.

27. The method of claim 22, wherein a fire-extinguishing agent is introduced into said fluid current.

28. The method of claim 22, wherein said fluid current is a wind generated artificially from an existing atmosphere, a matter stream, or a mass flow, or some combination thereof.

29. The method of claim 22, wherein said fluid current first assists with a deceleration of said flying object and said fluid current next assists with a lowering of said flying object from a hovering position onto said landing area.

30. The method of claim 22, wherein said fluid current first assists with an a lifting of said flying object from said takeoff area to a hovering position and said fluid current next assists with an acceleration of said flying object in a desired direction.

31. An apparatus for assisting a landing and/or takeoff of a powered flying object, comprising:
a stationary fluid current generator related to said landing and/or takeoff area;
wherein said generator is designed to provide said fluid current in order to introduce energy into said flying object.

32. The apparatus of claim 31, wherein said fluid current provided by said generator being adjustable.

33. The apparatus of claim 31, wherein said generator is designed so as to vary a value of at least one physical parameter of said fluid current.

34. The apparatus of claim 31, further comprising a heating element.

35. The apparatus of claim 31, further comprising a cooling element.

36. The apparatus of claim 31, further comprising a substance supply unit, wherein said substance supply unit introduces an additional substance into said fluid current.

37. The apparatus of claim 31, further comprising a fire-extinguishing agent supply unit, wherein said fire-extinguishing agent supply unit introduces a fire-extinguishing agent into said fluid current.

38. The apparatus of claim 31, further comprising at least one blower.

39. The apparatus of claim 38, wherein said blower further comprising at least one turbofan.

40. The apparatus of claim 31, wherein said generator provides as said fluid current a wind artificially generated from an existing atmosphere, a matter stream, or a mass flow, or some combination thereof.

41. The apparatus of claim 31, further comprising a control device for determining an optimum value of at least one parameter of said fluid current and for adjusting said at least one parameter value.

42. The apparatus of claim 41, wherein said at least one parameter comprises at least one of the following: direction of said fluid current, temperature of said fluid current, density of said fluid current, velocity of said fluid current, homogeneity of said fluid current, and laminarity rate of said fluid current.

43. The apparatus of claim 36, wherein said additional substance has a higher specific density than said fluid current.

44. A method for assisting the landing and/or takeoff of a powered flying object, comprising:
providing a stationary-generated fluid current relating to said landing and/or takeoff area in order to introduce energy into said flying object;
wherein a physical parameter of said fluid current is adjusted based on at least one external parameter.

45. The method of claim 44, wherein said at least one external parameter comprises at least one of: temperature, humidity, barometric pressure, wind speed, wind direction, a weight of said flying object, a shape of said flying object, aerodynamic features of said flying object, a power source for said flying object, dimensions of said landing and/or takeoff area, topography of said landing area.
